(19) United States
(12) Patent Application Publication
(10) Pub. No.: US 2025/0026081 A1
(43) Pub. Date: Jan. 23, 2025

(54) METHOD FOR PRODUCING AT LEAST ONE OBJECT IN LAYERS, WITH STEP-BY-STEP UPDATING OF THE COORDINATE TRANSFORMATION OF SCANNERS

(71) Applicant: TRUMPF Laser- und Systemtechnik GmbH, Ditzingen (DE)

(72) Inventors: Marc GRONLE, Renningen (DE); Joachim WAGNER, Stuttgart (DE); Matthias ALLENBERG-RABE, Ludwigsburg (DE); Oliver PFEFFERLE, Ludwigsburg (DE)

(21) Appl. No.: 18/906,276

(22) Filed: Oct. 4, 2024

Related U.S. Application Data
(63) Continuation of application No. PCT/EP2023/056342, filed on Mar. 13, 2023.

(30) Foreign Application Priority Data
Apr. 7, 2022 (DE) 10 2022 108 442.6

(51) Int. Cl. B29C 64/393; B29C 64/153; B29C 64/268; B33Y 10/00; B33Y 30/00; B33Y 50/02

(52) U.S. Cl. CPC B29C 64/393; B29C 64/153; B29C 64/268; B33Y 10/00; B33Y 30/00; B33Y 50/02

(57) ABSTRACT

A method for producing an object in layers by locally solidifying a pulverulent material includes scanning N high-energy beams simultaneously with N scanners, providing exposure data of a machining pattern in a reference coordinate system, converting the exposure data in the reference coordinate system into exposure data in a scanner coordinate system by using a programmed coordinate transformation, sending the exposure data in the scanner coordinate system to the associated scanner so that the associated scanner exposes the machining pattern in the respective layer, repeatedly taking measurements to determine current actual coordinate transformations of at least N−1 scanners, and updating the programmed coordinate transformations for the at least N−1 scanners, taking into account the current actual coordinate transformations. Multiple updates of the programmed coordinate transformations of the at least N−1 scanners are performed between two successive determinations of the current actual coordinate transformations.

### CROSS REFERENCE TO RELATED APPLICATIONS

This application is a continuation of International Application No. PCT/EP2023/056342 (WO 2023/194041 A1), filed on Mar. 13, 2023, and claims benefit to German Patent Application No. DE 10 2022 108 442.6, filed on Apr. 7, 2022. The aforementioned applications are hereby incorporated by reference herein.

### FIELD

Embodiments of the present invention relate to a method for producing at least one object on a building platform in layers by locally solidifying a pulverulent material in a respective layer.

### BACKGROUND

A method is known from EP 3 907 021 A1.

By producing objects in layers by locally solidifying pulverulent material using high-energy beams (usually laser beams or electron beams), three-dimensional objects can be produced comparatively easily and quickly. Geometric limitations of conventional production processes such as milling or injection molding can be overcome in this regard. The production in layers is often used for prototypes or for objects that are only produced in small quantities or even only once (such as dental crowns).

In order to achieve a fast production, multiple high-energy beams can also be used simultaneously on a building platform. For each high-energy beam there is a scanner (also referred to as a scanner system), which in the case of laser beams, for example, can comprise a mirror that can be adjusted by means of piezo actuators.

In order to produce a large object on the building platform, multiple high-energy beams are often used on the same object simultaneously. In a respective layer, the surface of the layer to be processed (solidified) resulting from the object is divided into partial surfaces, each of which is produced with one of the high-energy beams. The partial surfaces to be processed by the different high-energy beams make contact at boundary lines.

The different scanners for the high-energy beams are controlled by an electronic control device. According to the desired object to be produced, exposure patterns are generated from its 3D data for each layer to be produced and for each scanner, which are initially specified in a reference coordinate system. A scanner coordinate system is assigned to each scanner, and a respective scanner obtains the coordinates (exposure data) to be approached with the high-energy beam from the control device with reference to its scanner coordinate system. To this end, the exposure data for this scanner is converted from the reference coordinate system into the respective scanner coordinate system using a programmed coordinate transformation for the respective scanner. The reference coordinate system is usually linked to the processing machine (machine coordinate system), but the scanner coordinate system of a selected scanner (“guide scanner”) can also be selected as the reference coordinate system.

The coordinate transformation of a scanner, i.e., the relationship between the reference coordinate system and its scanner coordinate system, can be measured experimentally, as stated, for example, in EP 3 907 021 A1 or in WO 2018/086996 A1 or in WO 2019/173000 A1 or in DE 10 2018 205 403 A1. In general, the scanner is used in this regard to create one or multiple measuring points (for example reflexes or fused test patterns) with its high-energy beam on the building platform or a calibration object, the positions of which are determined relative to the reference coordinate system.

However, while producing a three-dimensional object on the building platform, the relative orientation of the scanners with respect to the building platform can change over time. This can be caused by temperature changes, gas pressure changes and humidity changes, for example. The different scanners are generally influenced in different ways by changes in orientation. In other words, the current actual coordinate transformations can change compared to the programmed coordinate transformations for the scanners (with the exception of the guide scanner, if one is provided for). As a result, the partial surfaces on the building platform processed by different scanners or their high-energy beams may be misaligned with respect to one another. This can create defects in the structure of the produced object in the region of the boundary lines of the partial surfaces of the individual layers, for example pore seams or local density fluctuations or even geometrical defects. This affects the quality of the produced object.

A variant is disclosed in EP 3 907 021 A1, which makes it possible to redetermine the current actual coordinate transformations of the other scanners during the production of an object on a building platform after every twelve produced layers, in each case, relative to a guide scanner and, as part of an update, to set the programmed coordinate transformations of the other scanners to the current actual coordinate transformations of the latest determination and to use them for the production of the next twelve layers.

This procedure allows the programmed coordinate transformations to be readjusted and adapted to changes in the orientation of the scanners. However, it should be noted that any determination of the current actual coordinate transformations always requires time that is then not available for producing the object as such (so-called non-productive time). In addition, there is a risk that between two successive determinations of the coordinate transformations there will be such strong changes to a current actual coordinate transformation that the update of the programmed coordinate transformation itself will lead to a defect in the structure of the object to be produced (for example, creating a visible offset in the object, also known as a “step”).

### SUMMARY

Embodiments of the present invention provide a method for producing at least one object on a building platform in layers by locally solidifying a pulverulent material in a respective layer. The method includes scanning, at least in a plurality of the layers, N high-energy beams at least temporarily simultaneously with N scanners, where N≥2. A scanner coordinate system is assigned to each respective scanner. The method further includes performing, by a control device for an exposure of a respective layer for each scanner, providing exposure data of a machining pattern in a reference coordinate system, converting the exposure data in the reference coordinate system into exposure data in the scanner coordinate system by using a programmed coordinate transformation, and sending the exposure data in the scanner coordinate system to the associated scanner so that the associated scanner exposes the machining pattern on the building platform in the respective layer. The method further includes, while producing the at least one object, repeatedly taking measurements to determine current actual coordinate transformations of at least N−1 scanners. Between two successive determinations of the current actual coordinate transformations, M layers are produced, where M≥2. The method further includes, while producing the at least one object, updating the programmed coordinate transformations for the at least N−1 scanners, taking into account the current actual coordinate transformations. Multiple updates of the programmed coordinate transformations of the at least N−1 scanners are performed between two successive determinations of the current actual coordinate transformations.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic cross-section of an exemplary system on which the method according to embodiments of the invention can be carried out and with which an object is produced on a building platform;

FIG. 2 shows a flow chart to explain the process of producing a layer of the object to be produced according to embodiments of the invention;

FIG. 3 shows a flow chart of a first variant of the method according to embodiments of the invention, in which the target coordinate transformation corresponds to the current actual coordinate transformation of the latest determination;

FIG. 4 shows a flow chart of a second variant of the method according to embodiments of the invention, in which the target coordinate transformation corresponds to the predicted coordinate transformation;

FIG. 5 shows four layer diagrams to explain four further variants of the method according to embodiments of the invention, with variations as to after how many produced layers a determination is carried out and with variations in the number and distribution of updates between two determinations;

FIG. 6 shows the performance of a seventh variant of the method according to embodiments of the invention in an exemplary manner, with a layer diagram, example calculations and a selection table;

FIG. 7a shows a diagram for an eighth variant of the method according to embodiments of the invention to show the determination of the predicted coordinate transformation by means of a polynomial regression;

FIG. 7b shows a diagram for a ninth variant of the method according to embodiments of the invention to show the determination of the predicted coordinate transformation by means of a linear regression; and

FIG. 8 shows a diagram for a tenth variant of the method according to embodiments of the invention to show the determination of the predicted coordinate transformation by means of a mean value formation.

### DETAILED DESCRIPTION

Embodiments of the present invention provide a method for producing at least one object on a building platform in layers, in which the object produced is high-quality while minimizing non-productive time.

According to embodiments of the present invention, at least in a plurality of the layers, N high-energy beams are at least temporarily used simultaneously with N scanners, where N≥2,
wherein a scanner coordinate system is assigned to a respective scanner in each case,
wherein a control device for an exposure of a respective layer for each scanner
   provides exposure data of a machining pattern in a reference coordinate system,
   converts the exposure data in the reference coordinate system into exposure data in the scanner coordinate system by means of a programmed coordinate transformation and
   directs the obtained exposure data in the scanner coordinate system to the associated scanner so that the scanner exposes the machining pattern on the building platform in the layer,
wherein, while producing the at least one object in layers, measurements are repeatedly taken, by means of each of which the current actual coordinate transformations of at least N−1 scanners are determined, wherein between two successive determinations of the current actual coordinate transformations, M layers are produced, where M≥2,
wherein, while producing the at least one object, the programmed coordinate transformations for the at least N−1 scanners are updated taking into account the current actual coordinate transformations,
and wherein multiple updates of the programmed coordinate transformations of the at least N−1 scanners are performed between two successive determinations of the current actual coordinate transformations.

According to embodiments of the present invention, between two successive determinations of the coordinate transformations of the at least N−1 scanners for a respective scanner, the programmed coordinate transformation is not readjusted in a single update, but in multiple updates.

This makes it possible to divide an accumulated or expected relative misadjustment of a respective scanner due to interfering influences such as temperature fluctuations (for example due to solar radiation), pressure fluctuations or humidity fluctuations (for example due to weather influences), which manifests itself in particular in a deviation between the last programmed coordinate transformation and the current actual coordinate transformation, into smaller individual corrections and to carry out multiple updates with these. This allows the programmed coordinate transformations of the scanners to be readjusted smoothly. Embodiments of the invention make it possible to minimize or completely avoid defects in the structure of the at least one object to be produced on the building platform at the boundary lines between two partial surfaces in a layer that are produced using different scanners.

In this regard, defects in the structure due to a relative misadjustment of the scanners relative to one another and/or to the building platform can be minimized or completely avoided as such, as well as by readjusting the programmed coordinate transformations of the at least N−1 scanners while processing the feed of the building platform. In particular, pore seams or density fluctuations or general geometrical defects and offsets (which would be visible on surfaces) are avoided in the regions of the boundary lines in the layers or in regions of corresponding cross-layer interfaces.

Determinations of the current actual coordinate transformation can be carried out comparatively rarely, as even larger accumulated relative misadjustments can be readjusted and compensated for without introducing noticeable defects into the structure of the object to be produced. This can reduce the amount of non-productive time and thus increase productivity.

The determination of the current actual coordinate transformations of the scanners (or scanner systems) is typically based on a measurement between the production of two layers; however, it is also possible that the determination is based on multiple partial measurements that are conducted in a manner distributed over the production of multiple layers. Measurements using which the current actual coordinate transformation of a scanner can be determined are known in the prior art as such and can be applied in the embodiments of the present invention; in particular, the methods described in EP 3 907 021 A1 or WO 2018/086996 A1 can be used as part of the method according to embodiments of the invention; the contents of these documents are hereby incorporated by reference into the present disclosure. For example, one or multiple test structures can be set up at defined locations on the building platform, and defined structures are introduced into the powder or regions that have already been fused by means of a repeated melting with all the high-energy beams or scanners involved; these structures can then be recorded with a camera (the structures then represent recordable measuring points). Alternatively, it is also possible to place such structures in separate regions (with their own building cylinders) outside of the actual building area/building platform. It is also possible to scan fixed markers or known bodies with all scanners using laser beams and ascertain their latest position, for example by detecting the laser light that is backscattered, back-reflected or generally emitted back, while utilizing a link with the position stamps of the scanners. In particular, a sapphire ball can be attached to the coater (which applies the powder to the building platform) as a quasi-retroreflector and occasionally introduced into the building space by the coater and scanned. Depending on the number of independent measuring points (per scanner), the relative position (with one or multiple measuring points) or the orientation/rotational position (with two or more measuring points) of the scanners relative to one another or relative to the machine coordinate system can be ascertained. In the case of determining the misadjustment of the N scanners relative to one another, i.e., for N−1 scanners relative to a guide scanner (the scanner coordinate system of which is then permanently defined as the reference coordinate system or as having a fixed relationship to the reference coordinate system), updates of the programmed coordinate transformations are usually carried out for N−1 scanners, and in the case of determining the misadjustment of the N scanners relative to a machine coordinate system, updates of the coordinate transformations are usually carried out for all N scanners.

The readjustment of the programmed coordinate transformations in the multiple updates between two determinations of the current actual coordinate transformations of the at least N−1 scanners takes into account at least the measured current actual coordinate transformations of the latest determination, and may also take into account the measured results of older determinations. In particular, algorithms from classic controllers can be used for the readjustment, in particular in order to limit the control variable (change in the programmed coordinate transformation) in a respective control step (update).

According to embodiments of the invention, the readjustment of the programmed coordinate transformation can be limited per update to a maximum value (with respect to offset and/or rotation), in particular to a determined maximum offset, for example to 5 μm or 10 μm or 15 μm per update for a spot diameter of approx. 80 to 100 μm; for larger spot diameters, a larger maximum offset can be selected and vice versa. In most cases, the readjusted maximum offset per update is in a range of 5% to 15% of the spot diameter of the associated high-energy beam. For example, the spot diameter can be determined according to the 86% criterion, such that 86% of the beam power lies in a circle with the spot diameter.

Between two determinations of the current actual coordinate transformations, U updates are carried out, where U≥2, preferably U≥5, and preferably U≥10. Between two determinations of the current actual coordinate transformations, a total of M layers are produced, wherein M≥2, preferably M≥5, preferably M≥10, most preferably M≥20. Note that M≥U. A respective update (or a then newly stored set of programmed coordinate transformations) then applies to the subsequent production of one or multiple layers.

A variant of the method according to embodiments of the invention is preferred, according to which,
after a respective latest determination of the current actual coordinate transformations for the at least N−1 scanners for a respective one of the at least N−1 scanners,
   taking into account the current actual coordinate transformation of the latest determination, a target coordinate transformation is ascertained,
   and with the multiple updates of the programmed coordinate transformation between the latest determination and the next determination, the programmed coordinate transformation is transformed step-by-step into the target coordinate transformation. The step-by-step transformation of the programmed coordinate transformation into the target coordinate transformation smoothly compensates for accumulated or expected misadjustments of the scanners and minimizes defects in the structure of the at least one object to be produced on the building platform. The newly programmed coordinate transformation with a respective update (a respective readjustment step) then applies to the production of one or multiple layers until the next update (the next readjustment step). Between the latest determination and the next determination, the programmed coordinate transformation is generally no longer changed until the next determination of the current actual coordinate transformation once the target coordinate transformation has been attained. If desired, a maximum change (offset and/or rotation) of the programmed coordinate transformation allowed in a single update can be defined for a respective scanner, typically with a maximum value between 2.5 μm and 25 μm for an offset and a maximum value between 0.05° and 1.0° for a rotation in the plane of the building platform.

According to a preferred further development of this variant, after a respective latest determination of the current actual coordinate transformations for the at least N−1 scanners for a respective one of the at least N−1 scanners,
an initial deviation between the target coordinate transformation and the programmed coordinate transformation, on which the latest determination was based, is ascertained,
the ascertained initial deviation is divided into multiple deviation portions,
and for the layers which are produced after the latest determination until the next determination of the current actual coordinate transformation, the programmed coordinate transformation is changed step-by-step in the multiple updates,
   wherein with each update a further deviation portion is added to a programmed coordinate transformation last applied by the control device. This procedure is simple and has proven itself in practice.

A sub-variant of this further development is advantageous, in which the ascertained initial deviation is divided into equally sized deviation portions. This allows for a smooth readjustment of the programmed coordinate transformation of a respective scanner to the associated target coordinate transformation. Typically, in this sub-variant, the multiple updates between two successive determinations are also carried out after producing an equal number of layers.

Alternatively, it is also possible to select deviation portions that are not equal. In particular, earlier updates in a determination interval can have larger deviation portions than later updates. It is also possible to select the first deviation portions in a determination interval according to a maximum permissible deviation portion (with regard to offset and/or rotation) in each case and to compensate for any remainder of the initial deviation in a final update.

In a further sub-variant, a respective deviation portion is limited by a maximum offset and/or a maximum rotation. This means that defects in the produced object (such as pore seams) can be avoided very reliably. A typical maximum offset per update is usually between 2.5 μm and 25 μm, and a maximum rotation per update is usually between 0.05° and 1.0° in the plane of the building platform.

A sub-variant of the above-mentioned further development is also preferred, in which between two determinations a number of U updates is carried out, wherein U=M is selected, and the initial deviation is divided into M equal deviation portions. In other words, an update of the programmed coordinate transformation is carried out for each layer, and the initial deviation is distributed evenly among the updates. This also allows for a smooth readjustment of the programmed coordinate transformation of a respective scanner to the associated target coordinate transformation.

A further development is preferred, in which the target coordinate transformation corresponds to the current actual coordinate transformation of the latest determination. The programmed coordinate transformation of a respective scanner is readjusted to the latest available experimental value of the current actual coordinate transformation until the next determination of the current actual coordinate transformation. In most applications, this already results in a good quality of the at least one produced object and is also easy to implement. No prognostic calculations or prognosis models are required, and results from previous determinations of the current actual coordinate transformations do not need to be used or stored. The procedure is useful for changes in the orientation of the scanner in relation to the building platform that cannot be predicted or can only be predicted with great uncertainty. If the current actual coordinate transformation cannot be achieved as the target transformation within a planned determination interval, for example because the initial deviation is too large for the planned number of updates and a maximum misadjustment of the programmed coordinate transformation per update, a coordinate transformation can alternatively be selected as the target transformation that lies between the current actual coordinate transformation and the coordinate transformation on which the latest determination was based.

Also preferred is a further development in which the target coordinate transformation is ascertained as a predicted coordinate transformation taking into account the current actual coordinate transformations of the latest determination and at least D, where D≥2, previously determined current actual coordinate transformations. In many applications, this can further increase the quality of the at least one produced object. For a respective layer, the programmed coordinate transformation of a respective scanner can be kept closer to the current actual coordinate transformation; usually, the programmed coordinate transformation is then also close to the current actual coordinate transformation at the point in time of a respective determination. By observing the current actual coordinate transformation over a large number of (known) points in time in the recent past, in many cases an expected coordinate transformation at a determined point in time in the future (“predicted coordinate transformation”) can be determined with good accuracy using model calculations. The future development of the misadjustment of a scanner can be anticipated by transforming the programmed coordinate transformation into this predicted coordinate transformation in the period up to this determined point in time. In particular, models such as those known from so-called state observers in control engineering can be used to determine the predicted coordinate transformation. D is usually selected as D≥3 or D≥5 or D≥10. If the predicted coordinate transformation cannot be achieved as the target transformation within a planned determination interval, for example because the initial deviation is too large for the planned number of updates and a maximum misadjustment of the programmed coordinate transformation per update, a coordinate transformation can alternatively be selected as the target transformation that lies between the predicted coordinate transformation and the coordinate transformation on which the latest determination was based.

According to a sub-variant of this further development, the predicted coordinate transformation is ascertained by means of a trend analysis. In this way, slow but uniform changes in the orientation of scanners, such as those that usually occur due to heating processes during the processing of the feed of the building platform, can be compensated for quite accurately.

Preferably, the trend analysis comprises a regression of the current actual coordinate transformation of the latest determination and the at least D, where D≥2, previously determined current actual coordinate transformations. A regression is easy to perform. In particular, the regression can be a linear regression, polynomial regression or exponential regression. In the case of a polynomial regression, four or fewer orders (per coordinate direction) are usually sufficient, and often three or fewer orders, and in some cases even two orders.

In another sub-variant, the target coordinate transformation is determined as a mean value of the current actual coordinate transformation of the latest determination and the at least D, where D≥2, previously determined current actual coordinate transformations. In other words, it is assumed that the actual coordinate transformation fluctuates around the mean value and in the future, as a prognosis, approaches the mean value again. This procedure is comparatively simple. It leads to good results if the current actual coordinate transformations used fluctuate mainly statistically, for example due to unsystematically and rapidly changing external conditions or also inherent statistical measurement errors. It is to be noted that a separate mean value is generally determined for each of the at least N−1 scanners.

A variant is preferred, in which the multiple updates between two successive determinations are each carried out after producing an equal number of layers. This helps to readjust the programmed coordinate transformations smoothly and to obtain a good degree of quality of the produced object.

In another preferred variant, the multiple updates between two successive determinations are each carried out after producing exactly one layer. In other words, an update only applies to a single layer to be produced in each case. This allows for a precise readjustment.

Further preferred is a variant, in which the multiple updates between two successive determinations are distributed evenly over the layers produced between two successive determinations. In other words, the entire period between two successive determinations is used to readjust the programmed coordinate transformations and the updates are carried out at (at least approximately) equal intervals. This can also help to make the readjustment smooth. Preferably, a number of U updates are carried out between two determinations, where U≥2, wherein an update is carried out, in each case, after producing M/U layers, where M/U is an integer. Typically, equal (added) deviation portions are also provided per update for the correction of the programmed coordinate transformation.

Preferred is a variant in which the number M of produced layers is variable between two successive determinations of the current actual coordinate transformations while producing the at least one object. This allows the frequency of determinations of the current actual coordinate transformations to be adapted to the requirements of the specific application and optimized, in particular with regard to a (specified or best possible) production accuracy and a (lowest possible or specified) proportion of non-productive time for measurements. If desired, M can be selected depending on temporal changes in measured values (such as pressure or temperature) within and/or in the environment of the 3D printing system; if, for example, a strong change in a measured value (which is typically accompanied by a significant misadjustment of the scanners) is observed, M should be selected to be smaller than for a small change.

In another preferred further development of this variant, the number M of produced layers or a moving average Mmov of the number M of produced layers between two successive determinations is selected to be lower at the beginning of the production of the at least one object in layers than in the further course of the production of the at least one object in layers. Experience has shown that at the beginning of production (i.e., after the fresh building platform has been placed in the coating chamber), settling processes still take place which are expected to cause major changes in the orientation of the scanners so that a more frequent verification of the coordinate transformations is recommended for accurate readjustment. In the later course of production, typically when a predetermined proportion of the layers (selected for example between 10% and 35% of the layers) or a predetermined minimum number of layers (selected for example as 100 or more, preferably 200 or more) has been produced or layers have been produced on the building platform for a predetermined minimum time since the start of production (selected for example between 1 h and 3 h), only small changes still occur, which means that a readjustment can be achieved in an easier manner with less frequent verifications of the coordinate transformation. The moving average Mmov can be formed, for example, over 4 or more, preferably 8 or more, and furthermore, for example, over 24 or fewer, and preferably 12 or fewer, determination intervals (i.e., values of M, typically the most recent values of M).

A further development is also preferred, in which the number M of layers to be produced between a latest determination and a next determination of the current actual coordinate transformation is selected depending on how large a neighbor deviation between the current actual coordinate transformation of the latest determination and the current actual coordinate transformation of the determination preceding the latest determination is for each of the at least N−1 scanners. This makes it possible to react in a flexible manner to interfering influences that occur during production.

In a preferred sub-variant of this further development, the number M of layers to be produced is selected to be smaller the greater the neighbor deviation is for the at least N−1 scanners. With the proposed procedure, the changes to the programmed coordinate transformations per determination interval can be kept to a minimum without selecting an unnecessarily short determination interval. Typically, a mean value is formed for the neighbor deviations in terms of absolute values of the coordinate transformations of the at least N−1 scanners, or the largest deviation that occurs in the N−1 scanners is ascertained and used for the size estimation.

A variant is preferred, in which
one of the N scanners is selected as the guide scanner,
the scanner coordinate system of the guide scanner or a further coordinate system with a fixed relationship to this scanner coordinate system is selected as the reference coordinate system, and between two successive determinations of the current actual coordinate transformations, multiple updates of the programmed coordinate transformations are performed only of the N−1 remaining scanners. For the guide scanner in the first alternative, the exposure data in the scanner coordinate system simultaneously corresponds to the exposure data in the reference coordinate system so that the selection of the guide scanner simultaneously sets the associated programmed coordinate transformation of the guide scanner to an identical representation. In a second alternative, the scanner coordinate system of the guide scanner is in a fixed relationship (for feeding the building platform) with the further coordinate system (reference coordinate system) so that the exposure data from the further coordinate system is converted into the scanner coordinate system using a fixed programmed coordinate transformation. For example, the further coordinate system can comprise the machine coordinate system or be identical to it. The programmed coordinate transformation of the guide scanner (e.g., the identical representation) is not updated between two determinations. The coordinate transformations of the other N−1 scanners are defined relative to the guide scanner or relative to its scanner coordinate system, and the coordinate transformations of the other N−1 scanners are, in each case, updated multiple times between two determinations. This procedure is simple and reliable. Faults in the measuring system usually affect the measuring points of all scanner systems (guide scanner and other scanners) equally and therefore have no effect on the (relative) readjustment of the N−1 other scanners. It is to be noted, however, that with this procedure, any changes in the relative orientation of the guide scanner with respect to the building platform during the production of the at least one object remain undetected and are not subject to readjustment. It should also be noted that in a 3D printing system according to embodiments of the invention, multiple sets of N scanners may also be provided (where N≥2, wherein N may be different for different sets), wherein each set comprises its own guide scanner, and the coordinate transformations of the remaining scanners of the respective set are readjusted with respect to the associated guide scanner or with respect to its reference coordinate system.

In an alternative variant, the reference coordinate system is a machine coordinate system of a processing machine comprising the N scanners and the building platform and multiple updates of the programmed coordinate transformations of the N scanners are performed between two successive determinations of the current actual coordinate transformation. With this procedure, changes in the orientation of all scanners can be detected and compensated for by updating the programmed coordinate transformations of the scanners. However, the measuring system on the processing machine should be stable in this case and not experience any noticeable disturbances that could falsify the determination of measuring points in the machine coordinate system. The machine coordinate system is typically defined directly or indirectly by the position of a machine component, wherein the machine component is stationary on the machine or is at least moved to a defined position (typically always the same within the scope of the positioning accuracy) for a respective determination, for example with the feeder. In particular, the machine coordinate system can be defined via a structure scanned with the scanners during a measurement, in particular via a retroreflector, such as a reflector sphere, or also via a measuring structure generated by a machine component, for example a light cross of an alignment laser.

A variant is preferred, in which the programmed coordinate transformations and the current actual coordinate transformations comprise only displacement information in two orthogonal directions. The two orthogonal directions (x, y) usually lie in the plane of the building platform. The determination of the displacement information is comparatively easy and is usually sufficient in practice, as rotations of the scanners usually do not occur at all, or only to a small extent, in practice. The displacement is also referred to as an offset.

In an alternative variant, the programmed coordinate transformations and the current actual coordinate transformations comprise displacement information in two orthogonal directions and rotation information in a plane spanned by the two orthogonal directions. The two orthogonal directions (x, y) usually lie in the plane of the building platform and the rotation takes place about the direction orthogonal thereto (z). By taking into account the rotation of the scanners, the programmed coordinate transformation can be readjusted with a particular degree of accuracy.

Embodiments of the present invention also provide a system for producing at least one object on a building platform in layers by locally solidifying pulverulent material in a respective layer, comprising a building platform, N scanners, where N≥2, and a control device, designed to carry out a method according to embodiments of the invention as described above. With the system according to embodiments of the invention, the at least one object can be produced with multiple scanners or associated high-energy beams with a high degree of quality and low non-productive times in a respective feed of a building platform.

Embodiments of the present invention also provide a computer program product which, when used on a system for producing at least one object on a building platform in layers by locally solidifying pulverulent material in a respective layer, carries out a method according to embodiments of the invention as described above.

Further advantages of the embodiments of the invention are evident from the description and the drawing. Similarly, the features mentioned above and the features still to be explained may each be used on their own or together in any desired combinations according to embodiments of the invention. The embodiments shown and described should not be understood as an exhaustive list, but rather as being of an exemplary character for the description of the invention.

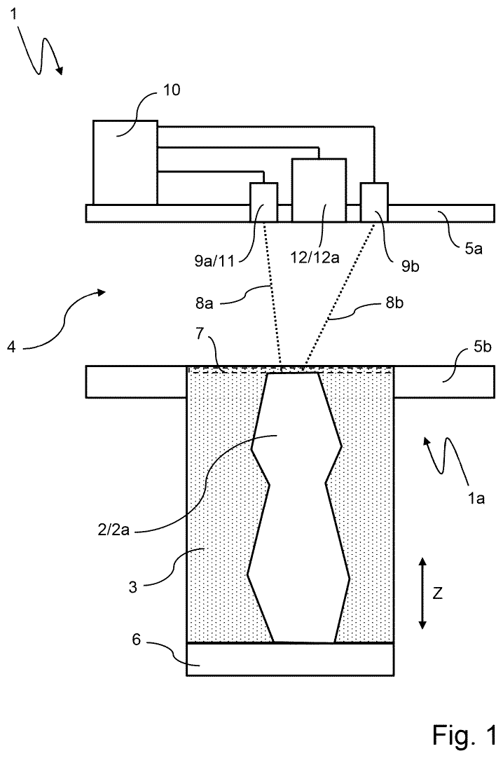

FIG. 1 schematically shows a system 1, comprising a processing machine 1a and a control device 10 according to embodiments of the invention. The system 1 is used to produce a three-dimensional object 2 from a pulverulent material 3. A computer program product that carries out the method according to embodiments of the invention can be executed on the system 1.

The processing machine 1a comprises a machining chamber 4 located within a housing. With respect to the housing, a cover 5a with further components (see below) and a floor 5b, which delimit the machining chamber 4, are shown here schematically. The machining chamber 4 is further delimited here by side walls and a rear wall (not shown in detail). The machining chamber 4 can be accessed via an access door (not shown in detail).

The production process is carried out on a building platform 6. The building platform 6 can be lowered along an axis in a direction Z relative to the floor 5b in order to gradually arrange new layers of pulverulent material 3 on the building platform 6 for producing the object 2 in layers; the application of the pulverulent material 3 is carried out by a feeder not shown in detail. In FIG. 1, the building platform 6 is already lowered relative to the floor 5b.

In order to produce the object 2, in this case a prototype 2a, an uppermost layer 7 of the pulverulent material 3 is irradiated with two high-energy beams 8a, 8b, in this case laser beams, which are directed onto the uppermost layer 7 by the, in this case two, scanners 9a, 9b. As shown here, the scanners 9a, 9b comprise tilting mirrors (not shown in detail). The high-energy beams 8a, 8b are directed to predetermined positions in the pulverulent material 3. The high-energy beams 8a, 8b are absorbed by the pulverulent material 3. The pulverulent material 3 melts and solidifies again when it is no longer being irradiated. The solidified material then forms a further part of the object 2 to be produced.

The two scanners 9a, 9b are connected to the control device 10. For the exposure of a respective layer 7, the control device 10 provides exposure data of a machining pattern in a reference coordinate system for each scanner 9a, 9b. The control device 10 can ascertain this exposure data from CAD data of the object 2 to be produced. The scanners 9a, 9b are each assigned a scanner coordinate system. In FIG. 1, the reference coordinate system corresponds to the scanner coordinate system of scanner 9a. The scanner 9a is then referred to as the guide scanner 11. Alternatively, a machine coordinate system of the processing machine 1a can also be selected as the reference coordinate system.

In the control device 10, the exposure data in the reference coordinate system is converted into exposure data in the scanner coordinate system for a respective scanner by means of a programmed coordinate transformation. For the scanner coordinate system of the guide scanner 11, the exposure data in the reference coordinate system and in the scanner coordinate system are identical. For the scanner coordinate system of the scanner 9b, the exposure data in the reference coordinate system differs from the exposure data in the scanner coordinate system. The exposure data is passed on to the associated scanner 9a, 9b in the respective scanner coordinate system. The scanners 9a, 9b then expose the machining pattern on the building platform 6 in the layer 7.

In FIG. 1, the processing machine 1a further comprises a monitoring device 12, in this case a camera 12a, using which the production is monitored. The monitoring device 12 is connected to the control device 10. While producing the object 2, measurements are repeatedly taken using the camera 12a. These repeatedly taken measurements are used to repeatedly determine the current actual coordinate transformation of the scanner 9b. In this regard, the current actual coordinate transformation of the scanner 9b can deviate from the programmed coordinate transformation on which the associated determination was based, as the ambient conditions and influences in the machining chamber 4 may change during production (for example, the machining chamber 4 may heat up during machining or there may be a change in differential pressure or humidity). This can cause the scanner 9b or its scanner coordinate system to displace or rotate relative to the guide scanner 11. In order to correct these displacements or rotations, the programmed coordinate transformation of the scanner 9b is updated, taking into account the current actual coordinate transformation of the scanner 9b.

It is to be noted that in the case that the reference coordinate system is a machine coordinate system, the current actual coordinate transformations for all scanners (9a, 9b) are repeatedly determined and updated by repeated measurements.

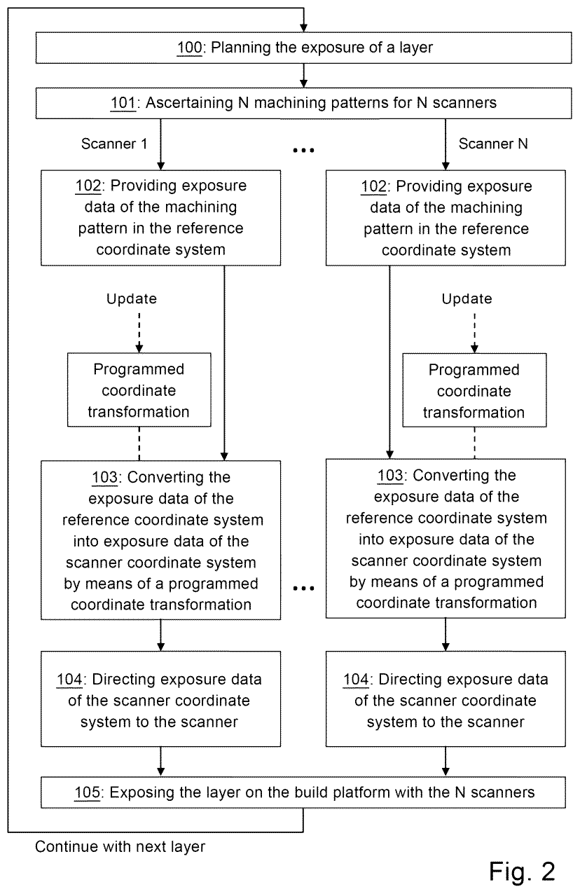

FIG. 2 shows a flow chart explaining how a single layer of an object to be produced is produced according to embodiments of the invention. Production is controlled by means of the control device.

Initially, in a step 100, the planning for exposure of a layer of the pulverulent material is carried out in order to produce a layer of the object. This involves ascertaining which surface areas of the entire layer of the pulverulent material need to be exposed to the high-energy beams of the scanners in order to produce the corresponding layer of the object (layer machining surface). The layer machining surface is essentially derived from the CAD data of the object and the position of the current layer in the object.

In the next step 101, the layer machining surface is distributed to the N scanners involved in producing the object. Accordingly, N machining patterns are ascertained for the N scanners. Typically, the N machining patterns are divided such that the machining time of each scanner is equally long, as far as possible. The following steps 102, 103, 104 are carried out separately for each of the N scanners.

In step 102, the exposure data (target position of the beam spot of the high-energy beam for a plurality of points in time) of the respective machining pattern of the respective scanner is first provided in the reference coordinate system.

In the following step 103, the exposure data in the reference coordinate system is converted into exposure data in the scanner coordinate system of the respective scanner. The conversion is carried out using the programmed coordinate transformation for this scanner.

In step 104, the exposure data in the scanner coordinate system is directed to the respective scanner (transferred for execution).

Then, in step 105, the layer on the building platform is exposed with the N scanners and the corresponding layer of the object is produced.

Once the exposure is complete, the process continues with producing the next layer (the process starts again at step 100).

In some embodiments, the programmed coordinate transformations are updated in certain ways, as described below.

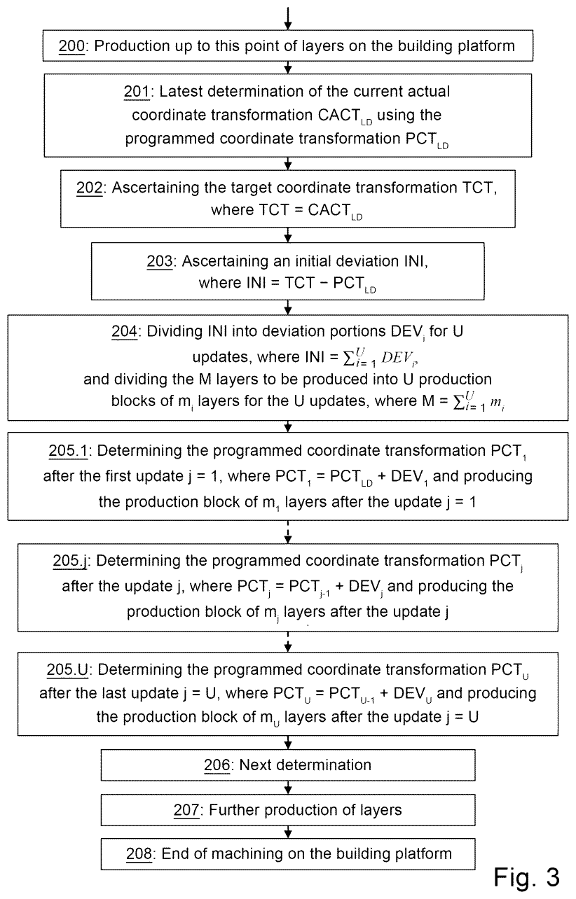

FIG. 3 shows a flow chart of a first variant of the method according to embodiments of the invention. If the reference coordinate system is defined as the machine coordinate system, this process is applied to all N scanners. If the reference coordinate system is defined as the scanner coordinate system of a guide scanner, this process is applied to N−1 scanners (i.e., all scanners except for the guide scanner).

In a step 200, layers have already been produced on the building platform in the variant shown and the object to be produced has already been partially produced accordingly. This can be described as the “production up to this point”.

In the next step 201, the latest determination of a current actual coordinate transformation CACTLD of the scanner is carried out. In this regard, the scanner is used in a measurement, wherein one or multiple measuring points were generated with the high-energy beam, known coordinates were specified in the reference coordinate system, which were converted into coordinates of the scanner coordinate system using a programmed coordinate transformation PCTLD on which the latest determination was based and directed to the scanner. The actual location of the measuring point(s) was then measured in the reference coordinate system (“actual coordinates”). The current actual coordinate transformation CACTLD can then be ascertained from the programmed coordinate transformation PCTLD of the latest determination plus a deviation, if any, of the specified known coordinates from the measured actual coordinates. Typically, the current actual coordinate transformation CACTLD will differ from the previously programmed coordinate transformation PCTLD during production due to changes in the ambient conditions in the machining chamber and the resulting misadjustments (displacements and possibly also rotations) of the scanners relative to one another or also of the scanners relative to the processing machine.

In order to correct these misadjustments, a target coordinate transformation TCT is ascertained in step 202. In the variant shown here, the target coordinate transformation TCT is equated with the current actual coordinate transformation CACTLD of the latest determination. The following therefore applies:

$$TCT = {CACT}_{L D} . \qquad ( Eq . l )$$

It is to be noted that the coordinate transformation comprises values for each coordinate direction (x, y) and possibly also a rotation (p), which can be considered individually, but are combined here into one formula symbol for simplification.

An initial deviation INI is then ascertained in step 203. The initial deviation INI results from the equation

$$INI = TCT - {PCT}_{L D} \qquad ( Eq . 2 )$$

and indicates how large the deviation of the target coordinate transformation TCT is from the programmed coordinate transformation PCT_{LD}.

In the following step 204, the ascertained initial deviation INI is divided into deviation portions DEVi for U updates, where i=1, . . . , U and where i=update index. The following then applies:

$$INI = {\sum }_{i = 1}^{U} {DEV}_{i} , \qquad ( Eq . 3 )$$

i.e., the sum of all deviation portions DEVi results in the initial deviation INI. Furthermore, the M layers to be produced that are to be produced until the next determination of the current actual coordinate transformation are divided into U production blocks, each with mi layers for the U updates. The following then applies:

$$M = {\sum }_{i = 2}^{U} {m}_{i} . \qquad ( Eq . 4 )$$

In step 205.1, a new programmed coordinate transformation PCT1 is determined after the first update j=1 (where j=1, . . . , U, and where j: index of the current update). The programmed coordinate transformation PCT1 results as follows:

$${PCT}_{1} = {PCT}_{L D} + {DEV}_{1} . \qquad ( Eq . 5 )$$

The new programmed coordinate transformation PCT₁ replaces the last valid programmed coordinate transformation (here PCT_{LD}) and is saved in the control device. The programmed coordinate transformation PCT₁ updated in this way is then used for producing the mi layers of the production block belonging to the first update.

The same procedure is used for further updates. Step 205.j shows the general case of determining a programmed coordinate transformation PCTj and of producing the production block of the mj layers after the update j. The programmed coordinate transformation PCTj results as follows:

$${PCT}_{j} = {PCT}_{j - 1} + {DEV}_{j} \qquad ( Eq . 6 )$$

which is equivalent to

$${PCT}_{j} = {PCT}_{1} + {\sum }_{i = 1}^{j} {DEV}_{i} . \qquad ( Eq . 7 )$$

The programmed coordinate transformation PCTⱼ is saved and then applied when producing the mⱼ layers of the production block belonging to the update j.

In step 205.U, a programmed coordinate transformation PCTU is determined after the last update j=U. The programmed coordinate transformation PCTU results as follows:

$${PCT}_{U} = {PCT}_{U - 1} + {DEV}_{U} \qquad ( Eq . 8 )$$

which is equivalent to

$${PCT}_{U} = {PCT}_{1} + {\sum }_{i = 1}^{U} {DEV}_{i} . \qquad ( Eq . 9 )$$

The programmed coordinate transformation PCT_{U} is saved and applied when producing the mu layers of the production block belonging to the last update j=U.

Step 206 follows, in which the next determination of the current actual coordinate transformation is performed. Subsequently, further layers can be produced and the programmed coordinate transformation can be updated as described in steps 202-205.U, and further determinations of the current actual coordinate transformation can be carried out, and so forth. This is summarized in step 207. Production is continued, i.e., the steps 201 to 205.U are repeated until the object is finished. In step 208, the machining of the object to be produced on the building platform is completed.

During the course of the first variant of the method according to embodiments of the invention, multiple updates (number U) of a programmed coordinate transformation PCT are performed between two successive determinations. This allows for dividing accumulated misadjustments of a scanner into small individual corrections and the programmed coordinate transformation PCT of the scanner can be readjusted smoothly. This can improve the quality of the object to be produced. Equating the current actual coordinate transformation CACTLD of the latest determination with the target coordinate transformation TCT is easy to implement and results in a good degree of quality of the object to be produced.

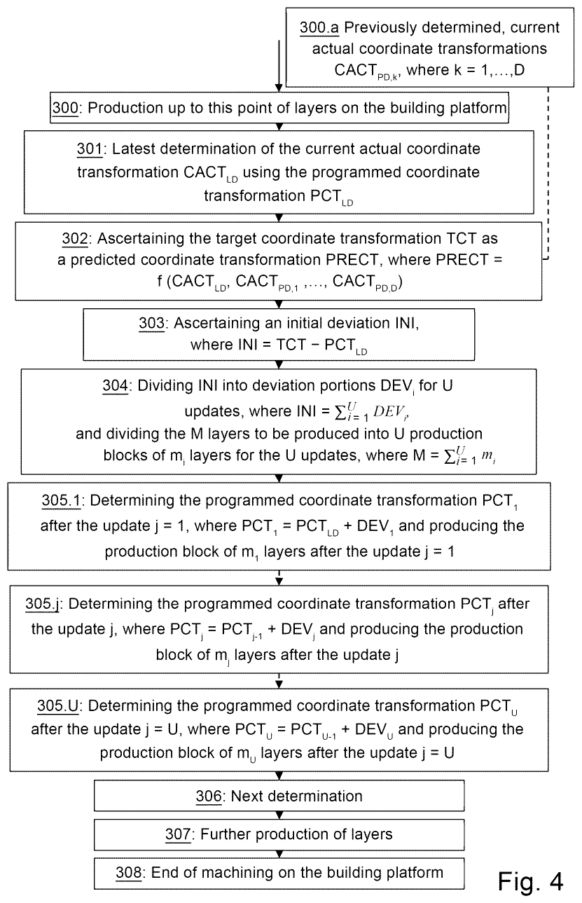

FIG. 4 shows a flow chart of a second variant of the method according to embodiments of the invention. If the reference coordinate system is defined as the machine coordinate system, this process is applied to all N scanners. If the reference coordinate system is defined as the scanner coordinate system of a guide scanner, this process is applied to N−1 scanners (i.e., all scanners except for the guide scanner). The course of the second variant largely corresponds to the course of the first variant (see FIG. 3) so that only the main differences are explained here.

In a step 300, layers have already been produced on the building platform and the object to be produced has already been partially produced. This can be described as the “production up to this point”. During the production up to this point, more current actual coordinate transformations of the scanner have already been determined, cf. step 300.a. The D (where D≥2) previously or last determined, current actual coordinate transformations CACTPD,k, where k=1, . . . , D and where k: counting index, are stored in the control device, together with the point in time at which they were determined.

In a next step 301, the latest determination of the current actual coordinate transformation CACTLD of the scanner is carried out.

In step 302, the target coordinate transformation TCT is defined. In the variant shown here, a predicted coordinate transformation PRECT is first ascertained for this purpose. The predicted coordinate transformation is a function of the latest determined, current actual coordinate transformation CACTLD and the further previously determined, current actual coordinate transformations CACTPD,k, where k=1, . . . , D (previous step 300.a). The predicted coordinate transformation PRECT is therefore determined as follows:

$$PRECT = f ( {CACT}_{L D} , {CACT}_{PD , 1} , … , {CACT}_{PD , D} ) . \qquad ( Eq . 10 )$$

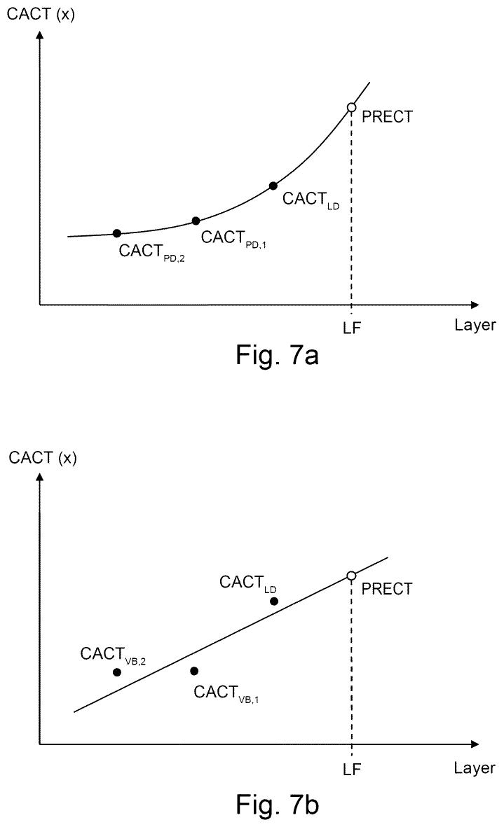

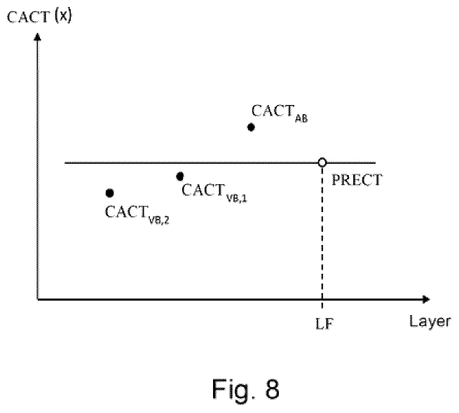

In this regard, f indicates a prognosis function. The predicted coordinate transformation PRECT can, for example, be determined by means of a trend analysis (for example a regression, see FIG. 7a, 7b) or by means of ascertaining a mean value (see FIG. 8). The target coordinate transformation TCT is then equated with the predicted coordinate transformation PRECT. The following therefore applies:

$$TCT = PRECT . \qquad ( Eq . 11 )$$

The target coordinate transformation TCT determined in this way can then be used to produce U production blocks of m layers in each case, where j=1, . . . , U, as described in steps 303-305.U, until the next determination of the current actual coordinate transformation 306 while performing U updates of the programmed coordinate transformation to the values PCTⱼ. Steps 303-308 correspond to steps 203-208 (see above).

During the course of the second variant of the method according to embodiments of the invention, multiple updates of the programmed coordinate transformation PCT are performed between two successive determinations. This allows for dividing accumulated and also expected misadjustments of a scanner into small individual corrections and the programmed coordinate transformation PCT of the scanner can be readjusted smoothly. This can improve the quality of the object to be produced. Equating the predicted coordinate transformation PRECT with the target coordinate transformation TCT allows for effective countermeasures to be taken against future developments in scanner misadjustments. A good degree of quality of the object to be produced can be achieved.

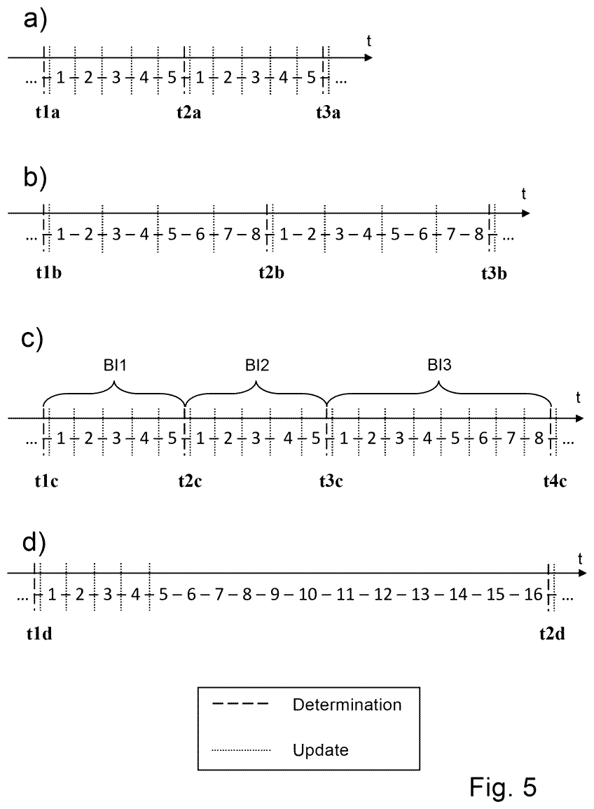

FIG. 5 shows further variants of the method according to embodiments of the invention using different layer diagrams for a single scanner. The layer diagrams are plotted against the time t and, in each case, show index numbers of the respective layers (Arabic numbers) that are produced between two determinations (determinations are shown as dashed lines) of the current actual coordinate transformation, as well as the number and distribution of updates (updates are shown as dotted lines) of the programmed coordinate transformation that are performed between two determinations.

It is to be understood that only characteristic determination intervals are shown in each case, and not the entire production process in a feed of the building platform.

Subfigure a) shows a third variant of the method according to embodiments of the invention. The current actual coordinate transformation is determined at the points in time t1a, t2a and t3a. Between the points in time t1a and t2a and between the points in time t2a and t3a, five layers (M=5) of the object to be produced are produced in each case. An update is carried out after each produced layer; five updates are therefore carried out between the points in time t1a and t2a and between the points in time t2a and t3a in each case.

After determining the current actual coordinate transformation at the point in time t1a, the initial deviation is ascertained and divided into five equally sized deviation portions, which are divided between the five updates until the next determination at the point in time t2a. The first update of the programmed coordinate transformation is then carried out and layer no. 1 is produced. Between layer no. 1 and layer no. 2, the programmed coordinate transformation is updated again and layer no. 2 is produced. Layers no. 3 to no. 5 are produced in the same way. After producing layer no. 5, the current actual coordinate transformation is determined at the point in time t2a.

The production of layers no. 1 to no. 5 between the points in time t2a and t3a is carried out in the same way as the production of layers no. 1 to no. 5 between the points in time t1a and t2a.

In this variant, the updates of the programmed coordinate transformation are carried out at equal intervals in small steps.

Subfigure b) shows a fourth variant of the method according to embodiments of the invention. The current actual coordinate transformation is determined at the points in time t1b, t2b and t3b. Eight layers (M=8) are produced, in each case, between the points in time t1b and t2b and between the points in time t2b and t3b. Here, the layers are divided into production blocks of two layers per production block in each case. An update is carried out after a production block has been produced; four updates are therefore carried out between the points in time t1a and t2a and between the points in time t2a and t3a in each case.

After determining the current actual coordinate transformation at the point in time t1b, the initial deviation is ascertained and divided into four equally sized deviation portions, which are divided between the four updates until the next determination at the point in time t2b. The first update of the programmed coordinate transformation is then carried out and layers no. 1 and no. 2 are produced. Between layer no. 2 and layer no. 3, the programmed coordinate transformation is updated again and layers no. 3 and no. 4 are produced. Layers no. 5 to no. 8 are produced in the same way. After producing layer no. 8, the current actual coordinate transformation is determined at the point in time t2b.

The production of layers no. 1 to no. 8 between the points in time t2b and t3b is carried out in the same way as the production of layers no. 1 to no. 8 between the points in time t1b and t2b.

In this variant, the updates are also carried out at the same intervals, but less frequently than in the variant in Subfigure a).

Subfigure c) shows a fifth variant of the method according to embodiments of the invention. In the variant shown here, the production of the object has only just begun. The current actual coordinate transformation is determined at the points in time t1c, t2c, t3c and t4c. Five layers are produced, in each case, between the points in time t1c and t2c and between the points in time t2c and t3c. Eight layers are produced between the points in time t3c and t4c. An update is carried out after each produced layer; five updates are carried out between the points in time t1c and t2c and between the points in time t2c and t3c in each case, and eight updates are carried out between the points in time t3c and t4c.

After determining the current actual coordinate transformation at the point in time t1c, the initial deviation is ascertained and divided into five equally sized deviation portions, which are divided between the five updates until the next determination at the point in time t2c (determination interval DI1). The first update of the programmed coordinate transformation is then carried out and layer no. 1 is produced. Between layer no. 1 and layer no. 2, the programmed coordinate transformation is updated again and layer no. 2 is produced. Layers no. 3 to no. 5 are produced in the same way. After producing layer no. 5, the current actual coordinate transformation is determined at the point in time t2c.

The production of layers no. 1 to no. 5 between the points in time t2c and t3c (determination interval DI2) is carried out in the same way as the production of layers no. 1 to no. 5 between the points in time t1c and t2c.

In the further course of the production in layers, the number of layers produced is increased here to eight layers between the points in time t3c and t4c (determination interval DI3). After determining the current actual coordinate transformation at the point in time t3c, the initial deviation is ascertained and divided into eight equally sized deviation portions, which are divided between the eight updates until the next determination at the point in time t4c. The first update of the programmed coordinate transformation is then carried out and layer no. 1 is produced. Between layer no. 1 and layer no. 2, the programmed coordinate transformation is updated again and layer no. 2 is produced. Layers no. 3 to no. 8 are produced in the same way. After producing layer no. 8, the current actual coordinate transformation is determined at the point in time t4c.

The determination intervals DI1 and DI2 represent early (processed first), shorter determination intervals, and the determination interval DI3 represents late (processed later), longer determination intervals. Processing the entire feed height of a building platform typically involves at least 20 determination intervals, and often at least 40 determination intervals.

In this variant, a more accurate and faster readjustment of the programmed coordinate transformation can be achieved at the start of the production of the object. Typically, greater changes in the orientation of the scanners are to be expected at the start of production, which is why determinations are made more frequently here at the beginning in order to control these changes and counteract them as quickly and accurately as possible. In most cases, the later determination intervals are at least 1.5 times as long as the earlier determination intervals, and often at least 2 times as long or even at least 3 times as long as the earlier processing intervals.

Subfigure d) shows a sixth variant of the method according to embodiments of the invention. The current actual coordinate transformation is determined at the points in time t1d and t2d. 16 layers are produced between the points in time t1d and t2d. Updates are only carried out at the beginning, namely before producing layers no. 1 to no. 5 in each case, i.e., a total of five updates are carried out.

After determining the current actual coordinate transformation at the point in time t1d, the initial deviation is ascertained and divided into five equally sized deviation portions, which are divided between the five updates. The first update of the programmed coordinate transformation is then carried out and layer no. 1 is produced. Between layer no. 1 and layer no. 2, the programmed coordinate transformation is updated again and layer no. 2 is produced. Layers no. 3 to no. 5 are produced in the same way. After producing layer no. 5, layers no. 6 to no. 16 are produced without further updates before the next determination of the current actual coordinate transformation is carried out at the point in time t2d.

In all the variants shown above, the initial deviation between two determinations was always divided into equally sized deviation portions. Alternatively, it is also possible to select deviation portions of different sizes between two determinations (not shown in detail). It should be noted in this regard that the deviation portions should not be selected as too large in order to avoid the formation of steps or offsets when producing the object to be produced.

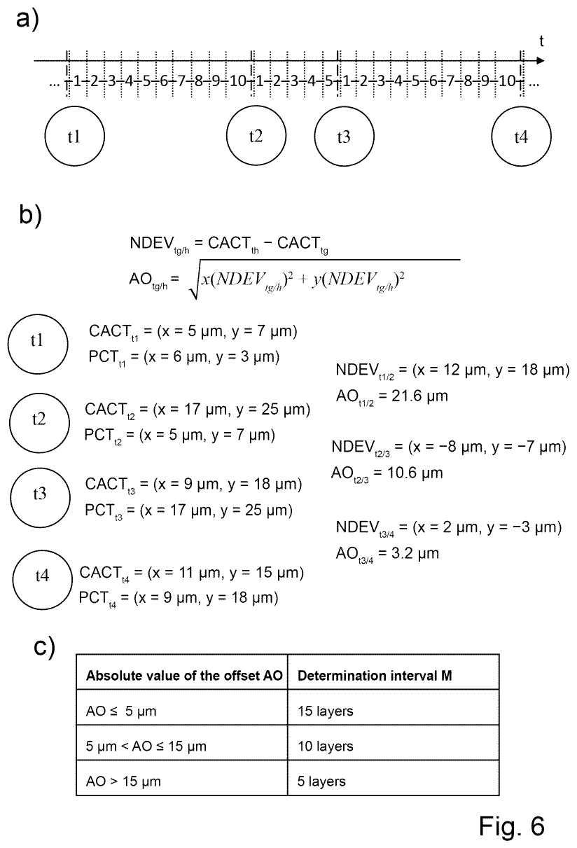

FIG. 6 shows the performance of a seventh variant of the method according to embodiments of the invention in an exemplary manner. In this variant, the current actual coordinate transformation determined in each case is equated with the target coordinate transformation.

Subfigure a) shows a layer diagram for a single scanner; the representation is analogous to FIG. 5 (see above).

The current actual coordinate transformation is determined at the points in time t1, t2, t3 and t4. Ten layers are produced, in each case, between the points in time t1 and t2 and between the points in time t3 and t4, and five layers are produced between the points in time t2 and t3. An update is carried out after each produced layer; ten updates are therefore carried out between the points in time t1 and t2 and between the points in time t3 and t4 in each case, and five updates are carried out between the points in time t2 and t3.

In the variant shown here, the number of layers produced between the determinations is determined using the neighbor deviations of the current actual coordinate transformations between the neighboring points in time t1, t2, t3, t4. In this regard, the neighbor deviations are determined using absolute values of the offset of the coordinate transformations. The exact procedure for this is explained in more detail in Subfigures b) and c).

Subfigure b) lists the determined current actual coordinate transformation and the programmed coordinate transformation on which the determination was based, in each case, at the points in time t1 to t4 for the selected example. The respective neighbor deviation and the absolute value of the offset between the points in time t1 and t2, t2 and t3 and t3 and t4 are also listed. In the variant shown here, the respective neighbor deviations NDEVtg/h are determined as follows:

$${NDEV}_{tg / h} = {CACT}_{th} - C A C {T}_{tg} \qquad ( Eq . 12 )$$

where tg and th: neighboring points in time, and where CACTtg and CACTth: determination of the current actual coordinate transformation at the points in time tg and th; h and g are the time indices, where h, in this case: 2, . . . , 4 and g: 1, . . . , 3.

In the variant shown here, the coordinate transformations or the associated displacement information and the neighbor deviations in a direction x and in a direction y are considered. The x-direction and the y-direction are orthogonal to one another and lie in the plane of the building platform. The absolute value of the offset AOtg/h of neighbor deviations between the neighboring points in time tg and th is determined as follows (using the Pythagorean theorem):

$$A {O}_{tg / h} = \sqrt{{x ( {NDEV}_{tg / h} )}^{2} + {y ( {NDEV}_{tg / h} )}^{2}} \qquad ( Eq . 13 )$$

Subfigure c) shows a table with selection criteria for the selected example. The determination interval, i.e., the interval of layers between the determinations, is adjusted according to the absolute value of the offset. Here, the selection criteria are selected such that 15 layers are produced between two determinations for AO≤5 μm, ten layers are produced between two determinations for 5 μm<AO≤15 μm and five layers are produced between two determinations for AO>15 μm.

Three examples will be used to further explain this variant of the method according to embodiments of the invention.

### Example 1

Between the points in time t1 and t2, ten layers were produced and ten updates of the programmed coordinate transformation were carried out, as can be seen in Subfigure a); this was defined without applying the table of Subfigure c). A comparison of the current actual coordinate transformation CACTₜ₁ at the point in time t1 and the current actual coordinate transformation CACTₜ₂ at the point in time t2 results in a neighbor deviation NDEV_{t1/2} for the x-coordinate of x=12 μm (as 17 μm-5 μm=12 μm) and for the y-coordinate of y=18 μm (as 25 μm-7 μm=18 μm). The absolute value of the offset AO_{t1/2} between the points in time t1 and t2 is then AO_{t1/2}=21.6 μm (as \sqrt{(12 μm)²+(18 μm)²}=21.6 μm). This offset is quite large. According to the selection criterion from the table in Subfigure c), this means that the interval of produced layers between the points in time t2 and t3 is selected as only five layers. This allows a further determination to be made earlier. The determination interval of M=5 layers is relatively small so that presumably only little offset will accumulate until the next determination.

### Example 2

Between the points in time t2 and t3, five layers were produced as previously specified, and five updates of the programmed coordinate transformation were carried out, as can be seen in Subfigure a). A comparison of the current actual coordinate transformation CACTₜ₂ at the point in time t2 and the current actual coordinate transformation CACTₜ₃ at the point in time t3 results in a neighbor deviation NDEV_{t2/3} for the x-coordinate of x=−8 μm (as 9 μm-17 μm=−8 μm) and for the y-coordinate of y=−7 μm (as 18 μm-25 μm=−7 μm). The absolute value of the offset AO_{t2/3} between the points in time t2 and t3 is then AO_{t2/3}=10.6 μm (as \sqrt{(−8 μm)²+(−7 μm)²}=10.6 μm). According to the selection criterion from the table in Subfigure c), this means that the interval of produced layers between the points in time t3 and t4 is selected as ten layers. This means that more layers are produced before a further determination is made than in the first example.

### Example 3

Between the points in time t3 and t4, ten layers were produced as previously specified, and ten updates of the programmed coordinate transformation were carried out, as can be seen in Subfigure a). A comparison of the current actual coordinate transformation CACTₜ₃ at the point in time t3 and the current actual coordinate transformation CACTₜ₄ at the point in time t4 results in a neighbor deviation NDEV_{t3/4} for the x-coordinate of x=2 μm (as 11 μm-9 μm=2 μm) and for the y-coordinate of y=−3 μm (as 15 μm-18 μm=−3 μm). The absolute value of the offset AO_{t3/4} between the points in time t3 and t4 is then AO_{t3/4}=3.2 μm (as \sqrt{(2 μm)²+(−3 μm)²}=3.2 μm). According to the selection criterion from the table in Subfigure c), this means that the interval of produced layers between the point in time t4 and the following point in time (not shown in more detail) is selected as 15 layers.

This variant of the method according to embodiments of the invention allows for a flexible adaptation to different situations while producing the object to be produced. In the case of large neighbor deviations, the determination intervals are shortened so that production can be monitored more precisely, and in the case of small neighbor deviations, the determination intervals are increased so that less time is required for measurements and production can be completed more quickly.

FIG. 7a shows the determination of the predicted coordinate transformation PRECT by means of a polynomial regression for an eighth variant of the method according to embodiments of the invention.

In the diagram, the x-coordinate of the current actual coordinate transformation CACT is plotted against the number of layers produced (the number of layers produced corresponds to a time coordinate). The diagram shows three determinations or measuring points (filled circles), namely two previously determined, current actual coordinate transformations CACTPD1 and CACTPD2 and the latest determined, current actual coordinate transformation CACTLD. There are the same number of produced layers between all measuring points here. A polynomial regression is carried out and a 2nd degree polynomial is fitted to the measuring points as the regression curve. The regression curve can be used to determine the predicted coordinate transformation PRECT at a future point in time or after producing a layer LF in the future (see empty circle).

Note that the determination of the predicted coordinate transformation PRECT is not only applied to the x-component, but accordingly also to the y-component and possibly a rotational component of the current actual coordinate transformation CACT (not shown in detail).

FIG. 7b shows the determination of the predicted coordinate transformation PRECT by means of a linear regression for a ninth variant of the method according to embodiments of the invention. Only the main differences to the variant in FIG. 7a are explained.

A linear regression is carried out and a regression curve in the form of a regression line is fitted to the measuring points. This can also be used to ascertain the predicted coordinate transformation PRECT at a selected future point in time or after producing a selected layer LF in the future.

FIG. 8 shows the determination of the predicted coordinate transformation PRECT by means of a mean value formation for a tenth variant of the method according to embodiments of the invention. Only the main differences to the variant in FIG. 7a are explained.

A mean value is determined from the three measuring points: The mean value is marked by the horizontally aligned straight line. It is assumed that the current actual coordinate transformation will settle around this mean value or return to this mean value. This can be used to determine the predicted coordinate transformation PRECT at the selected future point in time or after producing a selected layer LF in the future (see empty circle).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 System
1a Processing machine
2 Object
2a Prototype
3 Pulverulent material
4 Machining chamber
5a Cover
5b Floor
6 Building platform
7 Layer (here uppermost layer)
8a, 8b High-energy beam
9a, 9b Scanner
10 Control device
11 Guide scanner
12 Monitoring device
12a Camera
U Number of updates between two determinations
INI Initial deviation
DEVᵢ i-th deviation portion
D Number of previously determined current actual coordinate transformations used for the prognosis
DI1-DI3 Determination interval
AO_{tg/n} Absolute value of the offset of the current actual coordinate transformation between the neighboring points in time tg, th
g Index
h Index
i Index
j Index
k Index
M Number of layers produced between two determinations
mᵢ Number of layers in the production block after update i
CACT Current actual coordinate transformation
CACT_{LD} Current actual coordinate transformation of the latest determination
CACT_{tg} Current actual coordinate transformation at the point in time tg
CACTₜₕ Current actual coordinate transformation at the point in time th
CACT_{PD,k} Previously determined current actual coordinate transformation
N Number of scanners and number of high-energy beams
NDEV_{tg/h} Neighbor deviation of the current actual coordinate transformation between the points in time t_{g} and tₕ
PCT Programmed coordinate transformation
PCT₁ Programmed coordinate transformation after update 1
PCT_{U} Programmed coordinate transformation after update U
PCT_{LD} Programmed coordinate transformation on which the latest determination was based
PCTⱼ Programmed coordinate transformation after update j
PRECT Predicted coordinate transformation
LF Selected layer to be produced in the future
t Time
t1-t4 Point in time
t1a-t3a Point in time
t1b-t3b Point in time
t1c-t4c Point in time
t1d, t2d Point in time
tg Point in time
th Point in time
x Direction
y Direction
Z Direction
TCT Target coordinate transformation

1. A method for producing at least one object on a building platform in layers by locally solidifying a pulverulent material in a respective layer, the method comprising:
scanning, at least in a plurality of the layers, N high-energy beams at least temporarily simultaneously with N scanners, wherein N≥2, wherein a scanner coordinate system is assigned to each respective scanner,
performing, by a control device for an exposure of a respective layer for each scanner:
providing exposure data of a machining pattern in a reference coordinate system,
converting the exposure data in the reference coordinate system into exposure data in the scanner coordinate system by using a programmed coordinate transformation, and
sending the exposure data in the scanner coordinate system to the associated scanner so that the associated scanner exposes the machining pattern on the building platform in the respective layer,
while producing the at least one object, repeatedly taking measurements to determine current actual coordinate transformations of at least N−1 scanners, wherein between two successive determinations of the current actual coordinate transformations, M layers are produced, wherein M≥2, and
while producing the at least one object, updating the programmed coordinate transformations for the at least N−1 scanners, taking into account the current actual coordinate transformations,
wherein
multiple updates of the programmed coordinate transformations of the at least N−1 scanners are performed between the two successive determinations of the current actual coordinate transformations.

2. The method according to claim 1, further comprising:
after a respective latest determination of the current actual coordinate transformations for a respective one of the at least N−1 scanners,
taking into account the current actual coordinate transformation of the latest determination, ascertaining a target coordinate transformation, and
with the multiple updates of the programmed coordinate transformation between the latest determination and a next determination, transforming the programmed coordinate transformation step-by-step into the target coordinate transformation.

3. The method according to claim 2, further comprising, after the respective latest determination of the current actual coordinate transformations for the respective one of the at least N−1 scanners,
ascertaining an initial deviation between the target coordinate transformation and the programmed coordinate transformation, on which the latest determination was based, and
dividing the ascertained initial deviation into multiple deviation portions, and
for the layers which are produced after the latest determination until the next determination of the current actual coordinate transformation, changing the programmed coordinate transformation step-by-step in the multiple updates,
wherein with each update, a further deviation portion is added to the programmed coordinate transformation last applied by the control device.

4. The method according to claim 3, wherein the ascertained initial deviation is divided equally into the deviation portions.

5. The method according to claim 3, wherein each respective deviation portion is limited by a maximum offset and/or a maximum rotation.

6. The method according to claim 3, wherein,
between the two successive determinations, U number of updates is carried out, wherein U=M, and
the initial deviation is divided into M equal deviation portions.

7. The method according to claim 2, wherein the target coordinate transformation corresponds to the current actual coordinate transformation of the latest determination.

8. The method according to claim 2, wherein the target coordinate transformation is ascertained as a predicted coordinate transformation taking into account the current actual coordinate transformations of the latest determination and at least D previously determined current actual coordinate transformations, wherein D≥2.

9. The method according to claim 8, wherein the predicted coordinate transformation is ascertained by a trend analysis.

10. The method according to claim 9, wherein the trend analysis comprises a regression of the current actual coordinate transformation of the latest determination and the at least D previously determined current actual coordinate transformations.

11. The method according to claim 8, wherein the target coordinate transformation is determined as a mean value of the current actual coordinate transformation of the latest determination and the at least D previously determined current actual coordinate transformations.

12. The method according to claim 1, wherein each of the multiple updates between the two successive determinations is carried out after producing an equal number of layers.

13. The method according to claim 1, wherein each of the multiple updates between the two successive determinations is carried out after producing exactly one layer.

14. The method according to claim 1, wherein the multiple updates between the two successive determinations are distributed evenly over the M layers produced between the two successive determinations.

15. The method according to claim 1, wherein a value of M of the produced layers between two successive determinations of the current actual coordinate transformations is variable while producing the at least one object.

16. The method according to claim 15, wherein the value of M of the produced layers or a moving average of the value of M of the produced layers is selected to be lower at a beginning of the production of the at least one object in layers than in a further course of the production of the at least one object in layers.

17. The method according to claim 15, wherein the value of M of the layers to be produced between a latest determination and a next determination of the current actual coordinate transformation is selected depending on how large a neighbor deviation between the current actual coordinate transformation of the latest determination and the current actual coordinate transformation of a determination preceding the latest determination is for each of the at least N−1 scanners.

18. The method according to claim 17, wherein the value of M of the layers to be produced is selected to be smaller the greater the neighbor deviation is for the at least N−1 scanners.

19. The method according to claim 1, wherein,
one of the N scanners is selected as a guide scanner,
the scanner coordinate system of the guide scanner or a coordinate system with a fixed relationship to the scanner coordinate system of the guide scanner is selected as the reference coordinate system, and
between the two successive determinations of the current actual coordinate transformations, the multiple updates of the programmed coordinate transformations are performed only of the N−1 remaining scanners.

20. The method according to claim 1, wherein the reference coordinate system is a machine coordinate system of a processing machine comprising the N scanners and the building platform, and the multiple updates of the programmed coordinate transformations of the N scanners are performed between the two successive determinations of the current actual coordinate transformation.

21. The method according to claim 1, wherein the programmed coordinate transformations and the current actual coordinate transformations comprise only displacement information in two orthogonal directions.

22. The method according to claim 1, wherein the programmed coordinate transformations and the current actual coordinate transformations comprise displacement information in two orthogonal directions and rotation information in a plane spanned by the two orthogonal directions.

23. A system for producing at least one object on a building platform in layers by locally solidifying a pulverulent material in a respective layer, the system comprising a building platform, N scanners, wherein N≥2, and a control device,
configured to carry out a method according to claim 1.

24. A non-transitory computer-readable medium with a program code stored thereon, the program code, when executed by a system for producing at least one object on a building platform in layers by locally solidifying a pulverulent material in a respective layer, causing a method according to claim 1 to be performed.
